(19) United States
(12) Patent Application Publication
(10) Pub. No.: US 2002/0180110 A1
(43) Pub. Date: Dec. 5, 2002

(54) Laser marker and laser marking method

(75) Inventors: Toru Yamaguchi, Tokyo (JP); Masahiko Ikeno, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku, Tokyo (JP)

(21) Appl. No.: 09/985,010

(22) Filed: Nov. 1, 2001

(30) Foreign Application Priority Data
Jun. 4, 2001 (JP) 2001-168186

(51) Int. Cl. B23K 26/14

(52) U.S. Cl. 264/400; 425/174.4; 219/121.68

(57) ABSTRACT

It is an object of the present invention to form a marked dot with excellent visibility while inhibiting adherence to a semiconductor wafer of particles. A semiconductor wafer (1) is held on a wafer stage (2), and a laser beam (3) is radiated from above onto a predetermined marking position on the semiconductor wafer (1). A frame-like exhaust unit (10) having a frame form that surrounds an area (marking area) in which marking is performed by the laser beam (3) is provided adjacently over the semiconductor wafer (1). The exhaust unit (10) sucks a gas existing in the inside thereof, which enables effective collection of the particles generated when the laser beam (3) has high intensity.

### BACKGROUND OF THE INVENTION

1. Field of the Invention

The present invention relates to a laser marker for and a laser marking method of marking characters, codes and the like on a surface of a semiconductor wafer by radiating a laser beam onto the surface of the semiconductor wafer.

2. Description of the Background Art

In manufacturing a semiconductor device, a laser beam is radiated onto a surface of a semiconductor wafer for marking characters and codes. This marking allows discrimination of a semiconductor wafer by visual or automatic recognition.

FIG. 11 is a schematic view showing a structure of a conventional laser marker. Shown in FIG. 11 are: a semiconductor wafer 1; a wafer stage 2 for holding and moving the semiconductor wafer 1 so as to perform marking in a predetermined position; a laser oscillating unit 100 for oscillating a laser beam 3, which includes a laser oscillator, a power monitor, lenses, mirrors and the like; a movable mirror 101 for radiating the laser beam 3 from the laser oscillating unit 100 onto a marking position on the semiconductor wafer 1; and a marked dot 4 formed by radiation of the laser beam 3. Means for carrying the semiconductor wafer 1 to the wafer stage 2 and the like are omitted in the drawing.

The laser beam 3 radiated from the laser oscillating unit 100 is reflected by the mirror 101 for radiation onto the marking position on the surface of the semiconductor wafer 1 held by the wafer stage 2 in the predetermined position. The marked dot 4 is thereby formed in the marking position. A set of a plurality of marked dots 4 forms characters and codes.

FIG. 12 is an enlarged sectional view showing formation of the marked dot 4 on the semiconductor wafer 1 in the conventional laser marker. When radiating the laser beam 3 onto the semiconductor wafer 1, silicon included in the semiconductor wafer 1 is heated and melted in the radiated portion. The melted silicon is scattered around because of expansion. As a result, the portion radiated by the laser beam 3 is recessed at its center with its periphery rising up, and a resulting unevenness forms the marked dot 4.

FIG. 13 is an enlarged sectional view showing formation of the marked dot 4 on the semiconductor wafer 1 in the conventional laser marker when the laser beam 3 has low intensity, and FIG. 14 is a plan view showing the marked dot 4 formed at this time.

When the laser beam 3 has low intensity, a recess of the marked dot 4 becomes shallow as shown in FIG. 13. This results in marking with poor visibility as shown in FIG. 14. The marked dot 4 with poor visibility causes a problem in that recognition becomes difficult in the step of automatic recognition of marked characters and codes in a manufacturing step of a semiconductor device, resulting in decrease in the manufacturing efficiency of the semiconductor device.

To improve the visibility of a marked dot, the laser beam 3 should be increased in intensity. FIG. 15 is an enlarged sectional view showing formation of the marked dot 4 on the semiconductor wafer 1 in the conventional laser marker when the laser beam 3 has high intensity, and FIG. 16 is a plan view showing the marked dot 4 formed at this time.

When the laser beam 3 has high intensity, the recess of the marked dot 4 becomes deep as shown in FIG. 15. This allows the marked dot 4 to have good visibility as shown in FIG. 16. When the laser beam has high intensity, however, silicon melted by the laser beam 3 is scattered to generate particles 5 (which are generated during marking). Scatter of the particles 5 to a portion of the semiconductor wafer 1 where a product chip is to be formed causes a defect in the product chip, resulting in decrease in the yield of a semiconductor device. Even when the particles 5 are scattered not to the portion of the semiconductor wafer 1 where the product chip is to be formed but only in the vicinity of the marked dot 4, a similar problem might occur because the particles 5 move to the portion of the semiconductor wafer 1 where a product chip is to be formed in a subsequent step such as surface polishing. This is becoming a serious problem with the current trend moving toward greater densities and size reduction of a device.

Therefore, as shown in FIG. 17, there has been proposed a laser marker including an exhaust unit 110 sucking a gas to remove the particles 5 as shown in FIG. 17. The particles 5 generated by radiation of the laser beam are collected by the exhaust unit 110. This can inhibit the particles 5 from adhering to the semiconductor wafer 1.

In a structure as shown in FIG. 17, however, the gas velocity is high in the immediate vicinity of an exhaust port of the exhaust unit 110 while it is reduced with distance from the exhaust port. Thus, the gas velocity produced by suction of the exhaust unit 110 is reduced in a marking area on the semiconductor wafer 1, resulting in a disadvantage that all of the particles 5 cannot be collected and the remainder of the particles 5 that has not been collected is adhered to the surface of the semiconductor wafer 1.

### SUMMARY OF THE INVENTION

According to a first aspect of the present invention, a laser marker for performing marking by radiating a laser beam onto a surface of a semiconductor wafer comprises a frame-like exhauster configured to suck a gas, being provided in the vicinity of the surface of the semiconductor wafer and surrounding the laser beam, wherein the exhauster sucks the gas existing in the inside thereof.

According to a second aspect of the invention, in the laser marker of the first aspect, the exhauster moves in synchronization with the motion of the laser beam.

According to a third aspect of the invention, the laser marker of the first aspect further comprises a frame-like ejector configured to eject the gas, being provided between the exhauster and the semiconductor wafer and surrounding the laser beam, wherein the ejector ejects the gas to the inside thereof.

According to a fourth aspect of the invention, in the laser marker of the third aspect, the exhauster and the ejector move in synchronization with the motion of the laser beam.

According to a fifth aspect of the invention, a laser marker for performing marking by radiating a laser beam onto a surface of a semiconductor wafer comprises: a liquid supplier configured to supply a liquid on the surface of the semiconductor wafer; and a gas blower moving in synchronization with the motion of the laser beam and being configured to blow a gas to a position radiated by the laser beam on the surface of the semiconductor wafer.

According to a sixth aspect of the invention, a laser marking method of performing marking by radiating a laser beam onto a surface of a semiconductor wafer comprises the steps of: (a) radiating the laser beam; (b) sucking a gas from 360° directions with respect to a position radiated by the laser beam, the step (b) being executed simultaneously with the step (a).

According to the seventh aspect of the invention, in the laser marking method of the sixth aspect, the step (a) includes the step of moving the laser beam, and the step (b) includes the step of changing a position where the gas is sucked in synchronization with the motion of the laser beam.

According to an eighth aspect of the invention, the laser marking method of the sixth aspect further comprises the step of (c) ejecting the gas from the side of the semiconductor wafer with respect to a position where the gas is sucked and from 360° directions with respect to the position radiated by the laser beam, the step (c) being executed simultaneously with the step (a).

According to a ninth aspect of the invention, in the laser marking method of the eighth aspect, the step (a) includes the step of moving the laser beam, the step (b) includes the step of changing the position where the gas is sucked in synchronization with the motion of the laser beam, and the step (c) includes the step of changing a position where the gas is ejected in synchronization with the motion of the laser beam.

According to a tenth aspect of the invention, a laser marking method of performing marking by radiating a laser beam onto a surface of a semiconductor wafer comprises the steps of: (d) supplying a liquid on the surface of the semiconductor wafer; (e) blowing a gas to a position radiated by the laser beam on the surface of the semiconductor wafer, thereby sweeping the liquid existing in the position radiated by the laser beam; and (f) radiating the laser beam, the step (f) being executed simultaneously with the step (e).

As has been described, in the laser marker according to the first aspect, there are few positions on a marking area that are distant from an exhaust port for sucking the gas. Thus, there are few positions on the marking area where the gas velocity resulting from suction by the exhauster becomes low. This enables effective collection of particles generated when the laser beam has high intensity.

Therefore, it is possible to form a marked dot with excellent visibility while inhibiting particles from adhering to a semiconductor wafer.

In the laser marker according to the second aspect, the inside diameter of the exhauster can be reduced regardless of the size of the marking area on the semiconductor wafer. Thus, the exhaust port can be brought in close proximity to the marking position, which enables more effective collection of particles.

In the laser marker according to the third aspect, there is generated an upward gas flow flowing from an ejection port of the ejector into an exhaust port of the exhauster. Therefore, it is possible to inhibit adherence of particles to the semiconductor wafer and to collect particles effectively.

In the laser marker according to the fourth aspect, the inside diameters of the exhauster and the ejector can be reduced regardless of the size of the marking area on the semiconductor wafer. Thus, the exhaust port of the exhauster can be brought in close proximity to the marking position, which enables more effective collection of particles.

In the laser marker according to the fifth aspect, radiation of the laser beam is performed in a state that a position radiated by the beam is only that exposed from the liquid on a portion of the surface of the semiconductor wafer to which the liquid is supplied. Therefore, particles generated when the laser beam has high intensity adhere to the liquid surface and are swept away, without adhering to the surface of the semiconductor wafer.

Therefore, it is possible to form the marked dot with excellent visibility while inhibiting the particles from adhering to the semiconductor wafer.

With the laser marking method according to the sixth aspect, there are few positions on the marking area on the semiconductor wafer that are distant from the exhaust port for sucking the gas. Thus, there are few positions on the marking area where the gas velocity resulting from suction by the exhauster becomes low. This enables effective collection of particles generated when the laser beam has high intensity.

Therefore, it is possible to form the marked dot with excellent visibility while inhibiting the particles from adhering to the semiconductor wafer.

With the laser marking method according to the seventh aspect, the exhaust port for sucking the gas can be brought in close proximity to the marking position regardless of the size of the marking area on the semiconductor wafer. This enables more effective collection of particles.

With the laser marking method according to the eighth aspect, there is generated an upward gas flow flowing from an ejection port for ejecting the gas into an exhaust port for sucking the gas. Therefore, it is possible to inhibit adherence of particles to the semiconductor wafer and to collect particles effectively.

With the laser marking method according to the ninth aspect, the exhaust port for sucking the gas and the ejection port for ejecting the gas can be brought in close proximity to the marking position regardless of the size of the marking area on the semiconductor wafer. This enables more effective collection of particles.

With the laser marking method according to the tenth aspect, the step (f) is performed in a state that a position radiated by the beam is only that exposed from the liquid on a portion of the surface of the semiconductor wafer to which the liquid is supplied. Therefore, particles generated when the laser beam has high intensity adhere to the liquid surface and are swept away, without adhering to the surface of the semiconductor wafer.

Therefore, it is possible to form the marked dot with excellent visibility while inhibiting the particles from adhering to the semiconductor wafer.

An object of the present invention is to provide a laser marker and a laser marking method capable of generating a marked dot with excellent visibility while inhibiting adherence of particles to a semiconductor wafer.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a laser marker according to a first preferred embodiment of the invention;

FIG. 2 is an enlarged sectional view showing an operation of the laser marker according to the first preferred embodiment;

FIG. 3 shows a structure of a laser marker according to a second preferred embodiment of the invention;

FIG. 4 is an enlarged sectional view showing an operation of the laser marker according to the second preferred embodiment;

FIG. 5 shows a structure of a laser marker according to a third preferred embodiment of the invention;

FIG. 6 is an enlarged sectional view showing an operation of the laser marker according to the third preferred embodiment;

FIG. 7 shows a structure of a laser marker according to a fourth preferred embodiment of the invention;

FIG. 8 is an enlarged sectional view showing an operation of the laser marker according to the fourth preferred embodiment;

FIG. 9 shows a structure of a laser marker according to a fifth preferred embodiment of the invention;

FIG. 10 is an enlarged sectional view showing an operation of the laser marker according to the fifth preferred embodiment;

FIG. 11 is a schematic view showing a structure of a conventional laser marker;

FIG. 12 is an enlarged sectional view showing formation of a marked dot on a semiconductor wafer in the conventional laser marker;

FIG. 13 is an enlarged sectional view showing formation of a marked dot on a semiconductor wafer in the conventional laser marker when a laser beam has low intensity;

FIG. 14 is a plan view showing the marked dot formed on the semiconductor wafer in the conventional laser marker when the laser beam has low intensity;

FIG. 15 is an enlarged sectional view showing formation of a marked dot on a semiconductor wafer in the conventional laser marker when a laser beam has high intensity;

FIG. 16 is a plan view showing the marked dot formed on the semiconductor wafer in the conventional laser marker when the laser beam has high intensity; and

FIG. 17 shows a structure of a laser marker including a conventional exhaust unit for removing particles.

### DESCRIPTION OF THE PREFERRED EMBODIMENTS

<First Preferred Embodiment>

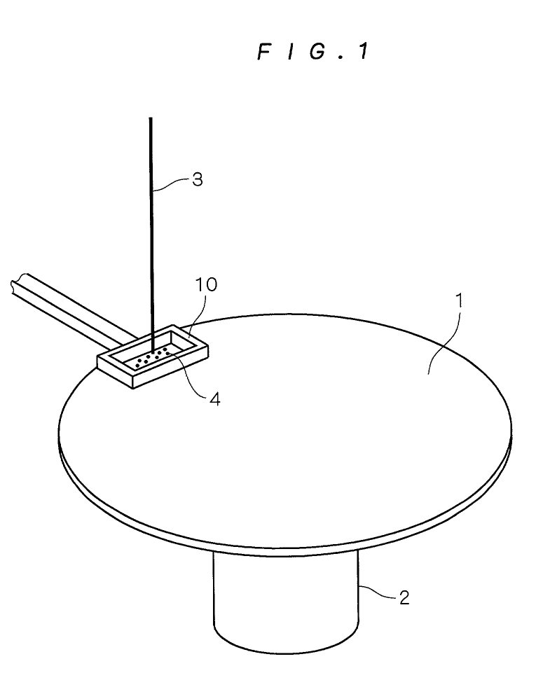

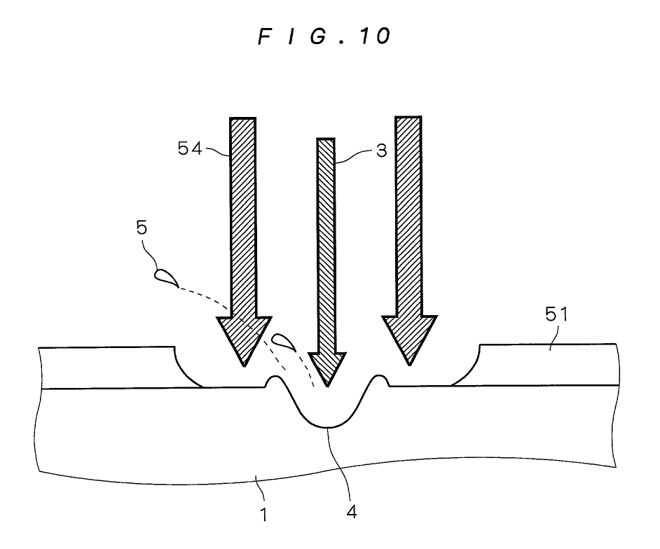

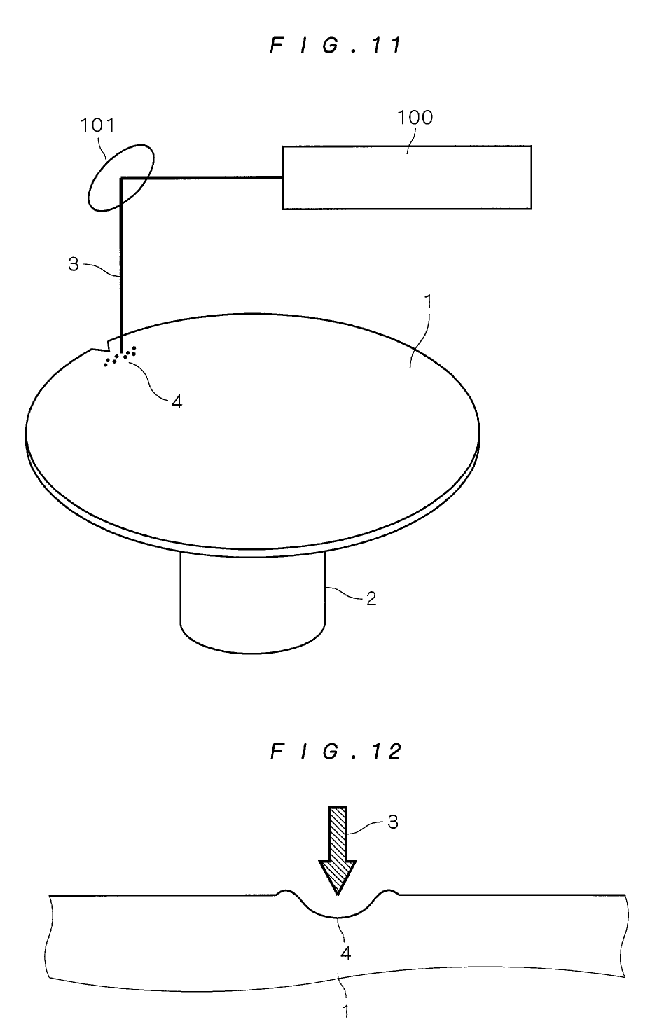

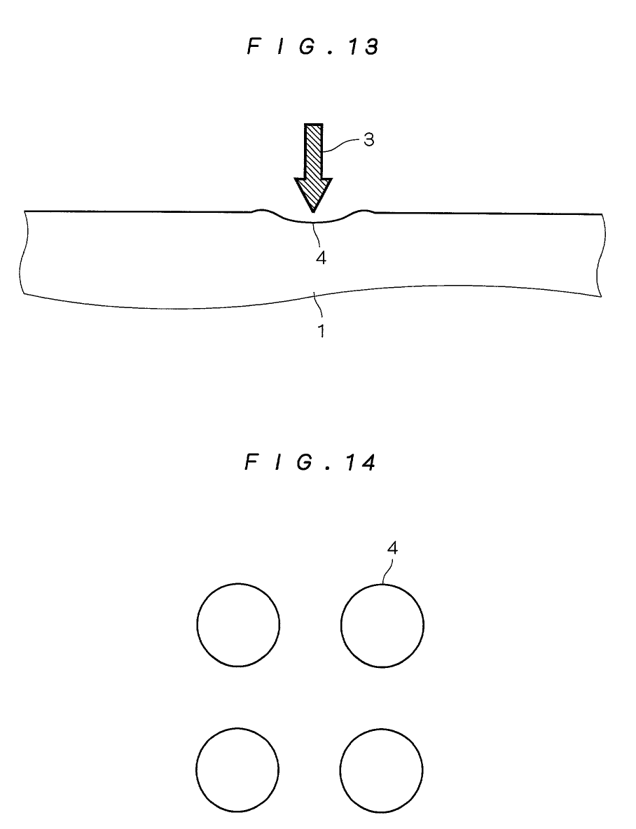

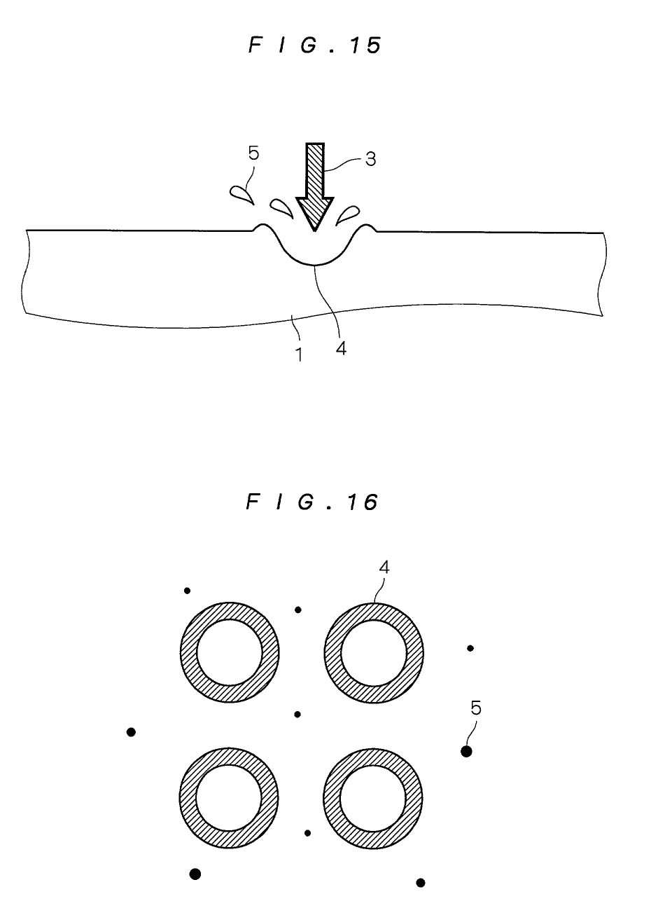

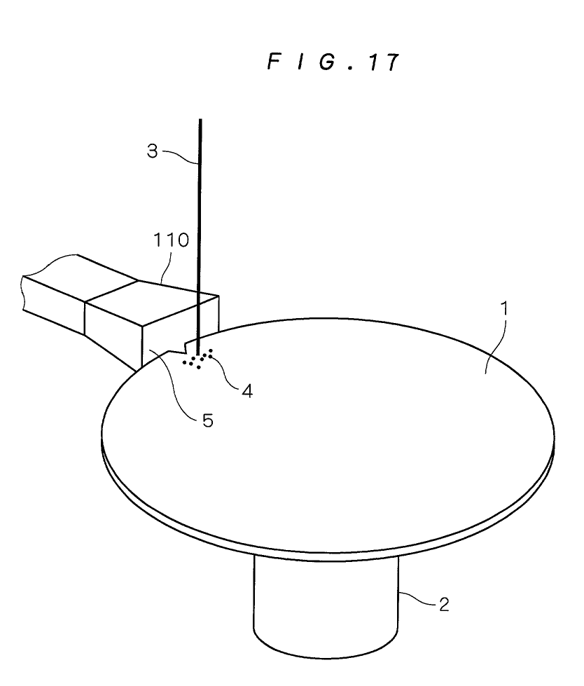

FIG. 1 shows a structure of a laser marker according to this first preferred embodiment. Elements similar to those shown in FIG. 11 in function are assigned the same reference characters, and detailed explanation is omitted here. The semiconductor wafer 1 is held on the wafer stage 2, and the laser beam 3 is radiated from above onto a predetermined marking position on the semiconductor wafer 1. A frame-like exhaust unit 10 surrounding an area (marking area) where marking is performed by the laser beam 3 sucks a gas existing inside the exhaust unit 10. The exhaust unit 10 is provided adjacently over the semiconductor wafer 1. In other words, the exhaust unit 10 sucks the gas from 360° directions with respect to a position radiated by the laser beam 3.

A laser oscillator oscillating the laser beam 3, a movable mirror radiating the laser beam 3 onto the marking position on the semiconductor wafer 1, means for carrying the semiconductor wafer 1 to the wafer stage 2 and the like are omitted from the illustration because of their little relevancy to the present invention.

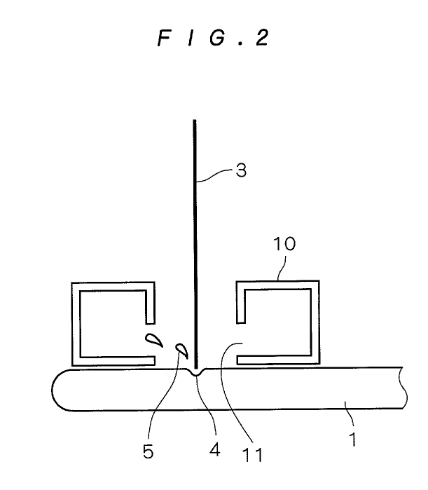

FIG. 2 is an enlarged sectional view showing an operation of the laser marker according to the present embodiment. The exhaust unit 10 has an exhaust port 11 provided in the inside thereof. Since the exhaust unit 10 has a form that surrounds the marking area, in other words, a form that surrounds the laser beam 3, the position radiated by the laser beam 3 on the semiconductor wafer 1 (the position where the marked dot is formed) falls inside the exhaust unit 10, and the particles 5 are generated inside the exhaust unit 10 as shown in FIG. 2. The particles 5 are sucked in through the exhaust port II inside the exhaust unit 10.

In the laser marker according to the present embodiment, the exhaust unit 10, being provided adjacently over the semiconductor wafer 1 and having a frame form that surrounds the marking area, sucks the gas from 360° directions with respect to the position radiated by the laser beam 3. This allows few positions on the marking area to be distant from the exhaust port. That is, there are few positions on the marking area where the air velocity becomes low. This enables effective collection of the particles 5.

Therefore, it is possible to inhibit adherence to the semiconductor wafer 1 of the particles 5 generated when the laser beam 3 has high intensity. This allows the marked dot to be formed with excellent visibility while inhibiting particles from adhering to a semiconductor wafer.

<Second Preferred Embodiment>

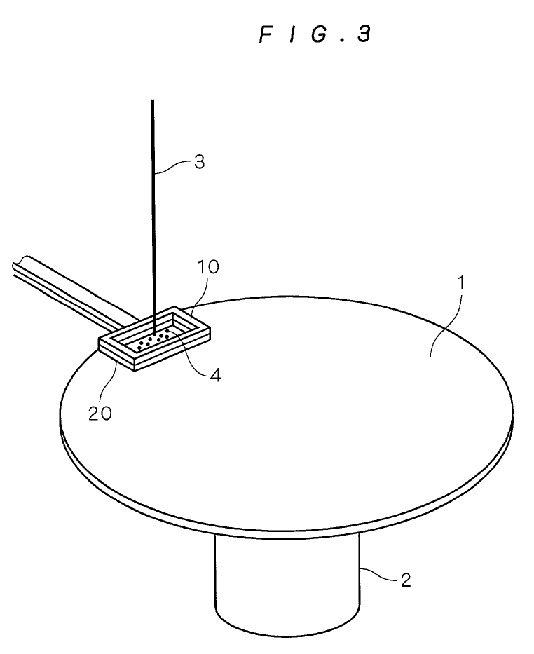

FIG. 3 shows a structure of a laser marker according to the second preferred embodiment. Elements similar to those shown in FIG. 1 in function are assigned the same reference characters, and detailed explanation is omitted here. The semiconductor wafer 1 is held on the wafer stage 2, and the laser beam 3 is radiated from above onto a predetermined marking position on the semiconductor wafer 1. Provided under the exhaust unit 10 is an ejection unit 20 having a form of a frame that likewise surrounds the marking area, which ejects a gas (e.g., dried air, oxygen, nitrogen, etc.) to the inside of the ejection unit 20. The exhaust unit 10 and the ejection unit 20 are provided adjacently over the semiconductor wafer 1. In other words, the ejection unit 20 ejects the gas from 360° directions with respect to the position radiated by the laser beam 3.

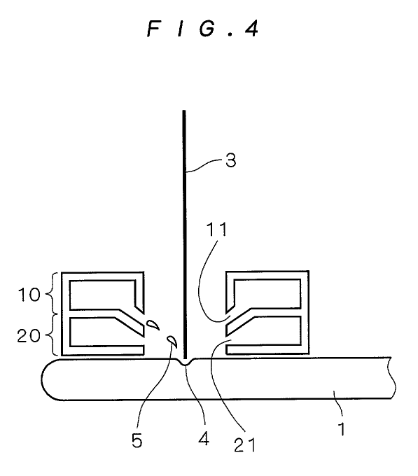

FIG. 4 is an enlarged sectional view showing an operation of the laser marker according to the present embodiment. The ejection unit 20 has an ejection port 21 provided in the inside thereof. Since the exhaust unit 10 and the ejection unit 20 each has such a form that surrounds the marking area, in other words, a form that surrounds the laser beam 3, the position radiated by the laser beam 3 on the semiconductor wafer 1 (the position where the marked dot is formed) falls inside the exhaust unit 10 and the ejection unit 20, and the particles are generated inside the exhaust unit 10 and the ejection unit 20 as shown in FIG. 4. Inside the exhaust unit 10 and the ejection unit 20, there is generated an upward gas flow flowing from the ejection port 21 into the exhaust port 11, causing the particles 5 to be sucked into the exhaust port 11.

As has been described, since the laser marker according to the present embodiment comprises the ejection unit 20 under the exhaust unit 10. Inside the exhaust unit 10 and the ejection unit 20, there is generated the upward gas flow flowing from the ejection port 21 into the exhaust port 11. Therefore, it is possible to inhibit adherence of the particles 5 to the semiconductor wafer 1.

Further, since the exhaust unit 10 and the ejection unit 20 are provided adjacently over the semiconductor wafer 1 and each has such a form that surrounds the marking area, there are few positions on the marking area that the air velocity becomes low. This enables effective collection of the particles 5.

Therefore, it is possible to inhibit adherence to the semiconductor wafer 1 of the particles 5 generated when the laser beam 3 has high intensity. This allows the marked dot to be formed with excellent visibility while inhibiting particles from adhering to a semiconductor wafer.

<Third Preferred Embodiment>

In the exhaust unit 10 as described above, there are fewer positions on the marking area that the air velocity becomes low with decrease in the inside diameter of the exhaust unit 10. However, the first preferred embodiment requires the exhaust unit 10 to surround at least the whole marking area, which puts limitations in reducing its inside diameter. Therefore, the third preferred embodiment describes a laser marker capable of reducing the inside diameter of a frame-like exhaust unit regardless of the size of a marking area.

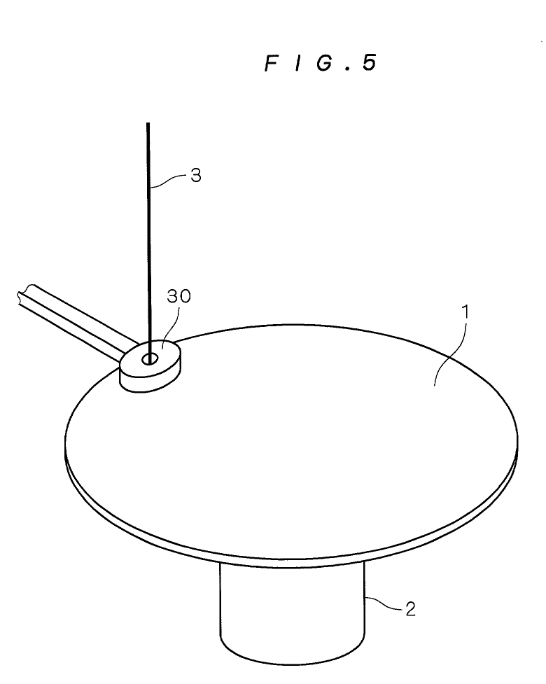

FIG. 5 shows a structure of a laser marker according to the present embodiment. Elements similar to those shown in FIG. 1 in function are assigned the same reference characters, and detailed explanation is omitted here. The semiconductor wafer 1 is held on the wafer stage 2, and the laser beam 3 is radiated from above onto a predetermined marking position on the semiconductor wafer 1. There is provided a movable frame-like exhaust unit 30 of a ring shape that surrounds the laser beam 3 for sucking a gas existing inside the exhaust unit 30 as well as moving in synchronization with the motion of the laser beam 3. More specifically, the exhaust unit 30 moves in such a manner that the laser beam always passes through the inside thereof. Further, the exhaust unit 30 is provided adjacently over the semiconductor wafer. In other words, the exhaust unit 30 sucks the gas always from 360° directions with respect to the position radiated by the laser beam 3.

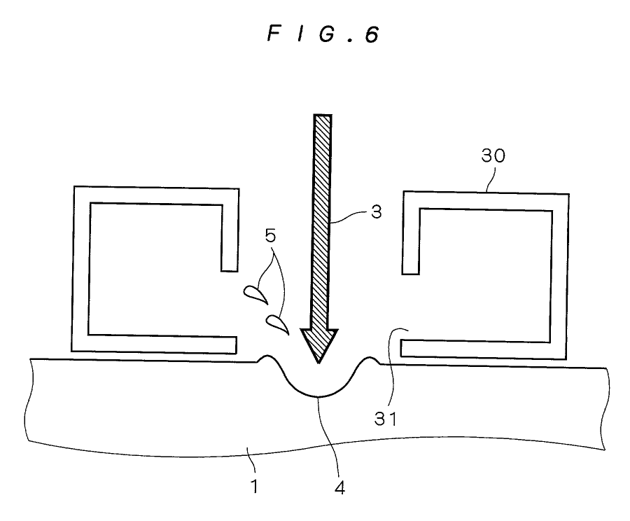

FIG. 6 is an enlarged sectional view showing an operation of the laser marker according to the present embodiment. The exhaust unit 30 has an exhaust port 31 provided in the inside thereof. Since the exhaust unit 30 always moves in such a manner as to surround the laser beam 3, the particles 5 are generated inside the exhaust unit 30 as shown in FIG. 6 and are sucked into the exhaust port 31 provided inside the exhaust unit 30.

In the laser marker according to the present embodiment, the exhaust unit 30 moves in synchronization with the motion of the laser beam 3, which enables reduction of the inside diameter of the exhaust unit 30 regardless of the size of the marking area. Thus, the exhaust port 31 can be brought in close proximity to the marking position, which enables more effective collection of the particles 5.

Therefore, it is possible to inhibit adherence to the semiconductor wafer 1 of the particles 5 generated when the laser beam 3 has high intensity, allowing the marked dot to be formed with excellent visibility while inhibiting particles from adhering to a semiconductor wafer.

<Fourth Preferred Embodiment>

FIG. 7 shows a structure of a laser marker according to the fourth preferred embodiment. Elements similar to those shown in FIG. 1 in function are assigned the same reference characters, and detailed explanation is omitted here. The semiconductor wafer 1 is held on the wafer stage 2, and the laser beam 3 is radiated from above onto a predetermined marking position on the semiconductor wafer 1. Provided under the exhaust unit 30 is a movable frame-like ejection unit 40 likewise surrounding the laser beam 3 and ejecting a gas to the inside thereof as well as moving in synchronization with the motion of the laser beam 3. More specifically, the exhaust unit 30 and the ejection unit 40 move in such a manner that the laser beam always passes through the insides thereof. Further, the exhaust unit 30 and the ejection unit 40 are provided adjacently over the semiconductor wafer. In other words, the ejection unit 40 ejects the gas from 360° directions with respect to the position radiated by the laser beam 3.

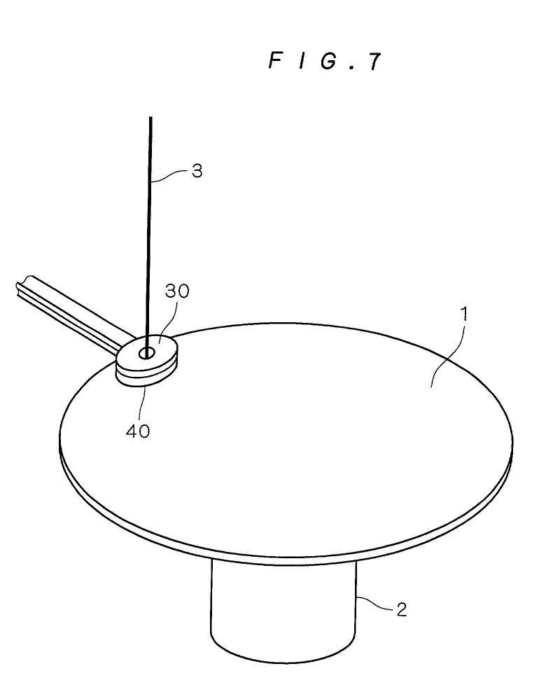

FIG. 8 is an enlarged sectional view showing an operation of the laser marker according to the present embodiment. The ejection unit 40 has an ejection port 41 provided in the inside thereof. Since the exhaust unit 30 and the ejection unit 40 always move in such a manner as to surround the laser beam 3, the particles 5 are generated inside the exhaust unit 30 and the ejection unit 40 as shown in FIG. 8. Inside the exhaust unit 30 and the ejection unit 40, there is generated an upward gas flow flowing from the ejection port 41 into the exhaust port 31, and the particles 5 are sucked into the exhaust port 31.

In the laser marker according to the present embodiment, the exhaust unit 30 and the ejection unit 40 move in synchronization with the motion of the laser beam 3, which enables reduction of the inside diameters of the exhaust unit 30 and the ejection unit 40 regardless of the size of the marking area. Thus, the exhaust port 31 and the ejection port 41 can be brought in close proximity to the marking position, which enables more effective collection of the particles 5.

Therefore, it is possible to inhibit adherence to the semiconductor wafer 1 of the particles 5 generated when the laser beam 3 has high intensity. This allows the marked dot to be formed with excellent visibility while inhibiting particles from adhering to a semiconductor wafer.

<Fifth Preferred Embodiment>

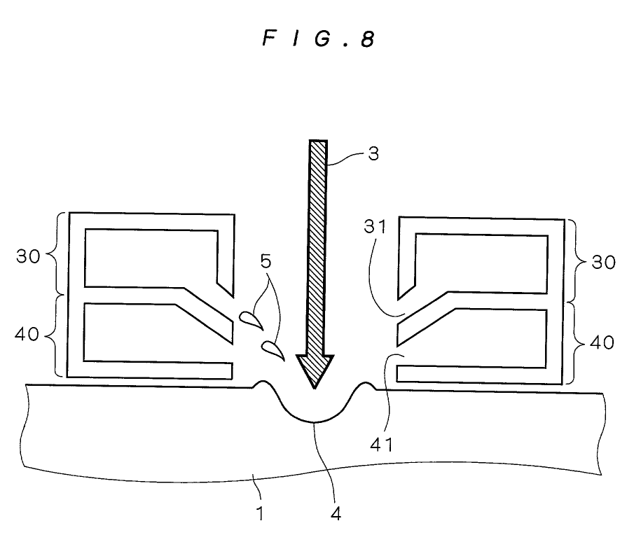

FIG. 9 shows a structure of a laser marker according to the fifth preferred embodiment. Elements similar to those shown in FIG. 1 in function are assigned the same reference characters, and detailed explanation is omitted here. The semiconductor wafer 1 is held on the wafer stage 2, and the laser beam 3 is radiated from above onto a predetermined marking position on the semiconductor wafer 1. There are provided a liquid supply unit 50 supplying a liquid 51 such as pure water on the semiconductor wafer 1, a liquid recovery unit 52 recovering the liquid 51 spilled over from the semiconductor wafer 1, and a gas blow unit 53 blowing a gas on the position radiated by the laser beam 3 on the semiconductor wafer 1.

Although FIG. 9 shows that the liquid 51 is supplied on a portion of the surface of the semiconductor wafer 1 that includes the marking position, a portion supplied with the liquid 51 may include at least the marking area and an area where the particles are scattered with marking, and the liquid 51 may be supplied on the entire surface of the semiconductor wafer 1, for example.

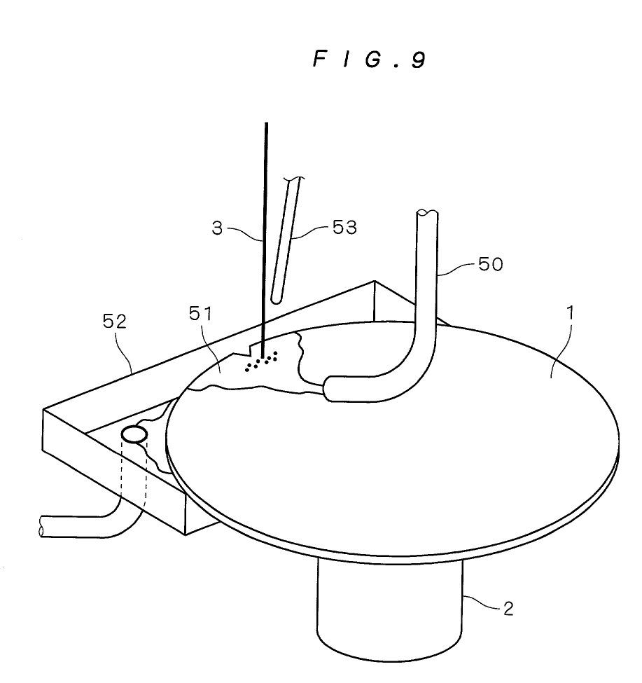

FIG. 10 is an enlarged sectional view showing an operation of the laser marker according to the present embodiment. The liquid supply unit 50 supplies the liquid 51 on the surface of the semiconductor wafer 1, so that the surface of the semiconductor wafer 1 is covered by the liquid 51. The gas blow unit 53 moves in synchronization with the motion of the laser beam 3 to blow a gas 54 onto the position radiated by the laser beam 3 on the semiconductor wafer 1. The gas 54 sweeps the liquid 51 in the position radiated by the laser beam 3 so that the surface of the semiconductor wafer 1 is exposed only in the position radiated by the laser beam 3 as shown in FIG. 10, and the marked dot 4 is formed in the exposed position by radiation of the laser beam 3. The particles 5 scattered at this time are adhered onto the liquid 51 and swept away into the liquid recovery unit 52 so that they are not adhered onto the surface of the semiconductor wafer 1.

Therefore, in the laser marker according to the present embodiment, it is possible to inhibit adherence to the semiconductor wafer 1 of the particles 5 generated when the laser beam 3 has high intensity, allowing the marked dot to be formed with excellent visibility while inhibiting particles from adhering to a semiconductor wafer.

Although the above preferred embodiments have shown the technique in which the wafer stage 2 holds the rear surface of the semiconductor wafer 1 at its center, the method of holding a semiconductor wafer is not limited as such, and may be changed within the scope to which the present invention is applicable.

Further, the exhaust port, the ejection port, the liquid supply unit, the gas blow unit and the like are not limited in their shapes, sizes, numbers, positions, etc., to those illustrated in the drawings used in the above explanation, but may be changed within the scope in which the effects of the present invention can be attained.

While the invention has been shown and described in detail, the foregoing description is in all aspects illustrative and not restrictive. It is therefore understood that numerous modifications and variations can be devised without departing from the scope of the invention.

What is claimed is:

1. A laser marker for performing marking by radiating a laser beam onto a surface of a semiconductor wafer, comprising
a frame-like exhauster configured to suck a gas, being provided in the vicinity of said surface of said semiconductor wafer and surrounding said laser beam, wherein
said exhauster sucks said gas existing in the inside thereof.

2. The laser marker according to claim 1, wherein
said exhauster moves in synchronization with the motion of said laser beam.

3. The laser marker according to claim 1, further comprising
a frame-like ejector configured to eject said gas, being provided between said exhauster and said semiconductor wafer and surrounding said laser beam, wherein
said ejector ejects said gas to the inside thereof.

4. The laser marker according to claim 3, wherein
said exhauster and said ejector move in synchronization with the motion of said laser beam.

5. A laser marker for performing marking by radiating a laser beam onto a surface of a semiconductor wafer, comprising:
a liquid supplier configured to supply a liquid on said surface of said semiconductor wafer; and
a gas blower moving in synchronization with the motion of said laser beam and being configured to blow a gas to a position radiated by said laser beam on said surface of said semiconductor wafer.

6. A laser marking method of performing marking by radiating a laser beam onto a surface of a semiconductor wafer, comprising the steps of:
(a) radiating said laser beam;
(b) sucking a gas from 360° directions with respect to a position radiated by said laser beam, said step (b) being executed simultaneously with said step (a).

7. The laser marking method according to claim 6, wherein
said step (a) includes the step of moving said laser beam, and
said step (b) includes the step of changing a position where said gas is sucked in synchronization with the motion of said laser beam.

8. The laser marking method according to claim 6, further comprising the step of
(c) ejecting said gas from the side of said semiconductor wafer with respect to a position where said gas is sucked and from 360° directions with respect to said position radiated by the laser beam, said step (c) being executed simultaneously with said step (a).

9. The laser marking method according to claim 8, wherein
said step (a) includes the step of moving said laser beam,
said step (b) includes the step of changing said position where said gas is sucked in synchronization with the motion of said laser beam, and
said step (c) includes the step of changing a position where said gas is ejected in synchronization with the motion of said laser beam.
